(19) United States
(12) Patent Application Publication
(10) Pub. No.: US 2024/0134074 A1
(43) Pub. Date: Apr. 25, 2024

(54) AI-DRIVEN CABLE MAPPING SYSTEM (CMS) EMPLOYING FIBER SENSING AND MACHINE LEARNING

(71) Applicant: NEC Laboratories America, Inc., Princeton, NJ (US)

(72) Inventors: Ming-Fang HUANG, Princeton, NJ (US); Chaitanya Prasad NARISETTY, Andhra Pradesh (IN)

(73) Assignee: NEC Laboratories America, Inc., Princeton, NJ (US)

(21) Appl. No.: 18/485,187

(22) Filed: Oct. 11, 2023

Related U.S. Application Data
(60) Provisional application No. 63/415,394, filed on Oct. 12, 2022.

(51) Int. Cl. G01V 1/00; G01C 21/00; H04L 41/14

(52) U.S. Cl. CPC G01V 1/001; G01C 21/3848; H04L 41/145

(57) ABSTRACT

An AI-driven cable mapping system that employs distributed fiber optic sensing (DFOS) fiber sensing and machine learning that provides autonomous determination of fiber optic cable location and mapping of same. Designed Al algorithms operating within our inventive systems and methods provide an easy solution for cable mapping in a GIS system; automatically maps using landmarks and manhole locations; and employs a supervised learning algorithm. A vehicle-assist operation is employed wherein a vehicle carries a Global Positioning System (GPS) device and drives along a roadway thereby following the fiber optic cable route; data paring that provides further significant locational information wherein time synchronizes between the DFOS system and vehicle GPS device from which we automatically pair the data of fiber length from traffic trajectories and GPS coordinates by time series.

### CROSS-REFERENCE TO RELATED APPLICATIONS

This application claims the benefit of United States Provisional Patent Application Serial No. 63/415,394 filed Oct. 12, 2022, the entire contents of which is incorporated by reference as if set forth at length herein.

### FIELD OF THE INVENTION

This application relates to distributed fiber optic sensing (DFOS)/distributed acoustic sensing (DAS) systems, methods, and structures and artificial intelligence, machine learning (ML) technologies. More particularly, it pertains to an artificial intelligence driven cable mapping system (CMS) employing fiber sensing and machine learning.

### BACKGROUND OF THE INVENTION

Optical fiber mapping—the mapping/locating of optical fiber to maps—is a

continuous problem for telecommunications carriers and cable providers since there currently are millions of miles of optical fibers in country that provide 5G and numerous other services. Oftentimes, route information pertaining to deployed optical fibers relies on prior information and knowledge of fiber optic cable installation and orientation, which can sometimes be acquired from construction maps of deployment sites or notes and photos that may be taken during the construction/deployment. Most of the time, however, such information is not up to date.

When this deployment information is non-existent or unavailable, it presents significant labor and cost challenges for operators/service providers to locate the exact location(s) of the fiber optic cable(s). Unfortunately, there is no system/method that automatically determines and maps locations of field-deployed fiber optic cable(s).

### SUMMARY OF THE INVENTION

The above problem is solved and an advance in the art is made according to aspects of the present disclosure directed to an AI-driven cable mapping system that employs fiber sensing and machine learning.

In sharp contrast to the prior art, systems, and methods according to aspects of the

present disclosure provide for the autonomous determination of fiber optic cable location and mapping of same that employ fiber optic sensing technology integrated with vehicle-assist methods and environmental landmarks for fiber optic cable localization and route mapping. Advantageously, our designed Al algorithms operating within our inventive systems and methods: provide an easy solution for cable mapping in a GIS system; automatically maps using landmarks and manhole locations; and employs a supervised learning algorithm.

As we shall show and describe, we further disclose: a vehicle-assist method wherein a vehicle carries a Global Positioning System (GPS) device and drives along a roadway thereby following the fiber optic cable route; data paring that provides further significant locational information wherein time synchronizes between the DFOS system and vehicle GPS device from which we automatically pair the data of fiber length from traffic trajectories and GPS coordinates by time series.

In further contrast to the prior art, our inventive systems and methods employ field reference points that may advantageously using landmarks (buildings/roadways/manholes/etc.) as reference points that facilitate self-calibration using GPS coordinates from the landmarks (e.g., start/end central offices of the route).

Finally, our inventive deep neural network (DNN) is trained in an end-to-end manner along the entire length of the DFOS sensor fiber and produces accurate results while allowing generalize solutions from a trained route to be applied to new routes. As those skilled in the art will understand and appreciate, our disclosure describes a combination DFOS system and AI/ML techniques as an integrated solution that automatically maps an optical fiber along an entire fiber optic cable route which heretofore has plagued the art.

### BRIEF DESCRIPTION OF THE DRAWING

FIG. 1(A) and FIG. 1(B) are schematic diagrams showing an illustrative prior art uncoded and coded DFOS systems;

FIG. 2. Is a schematic flow diagram showing an illustrative prior art method for determining fiber optic cable location and mapping;

FIG. 3 is a schematic flow diagram showing an illustrative method for determining fiber optic cable locations and mapping according to aspects of the present disclosure;

FIG. 4 is a schematic diagram showing illustrative system setup for determining fiber optic cable locations and mapping according to aspects of the present disclosure;

FIG. 5 is a schematic diagram showing illustrative field operations of AI-driven cable mapping system including fiber route map, sensing data received from DFOS system, and GPS coordinates from GPS device, according to aspects of the present disclosure;

FIG. 6(A), FIG. 6(B), FIG. 6(C), and FIG. 6(D) are a series of plots showing operations data of automatic, AI-driven CMS according to the present disclosure in which: FIG. 6(A) shows received sensing data (waterfall traces) from DFOS system including survey vehicle and road traffic; FIG. 6(B) shows coordinated GPS information and DFOS sensing points based on timestamps with field reference points shown on map as dots; FIG. 6(C) is a trajectory plot if field reference point is matched; and FIELD 6(D) is a trajectory plot when 2 field reference points are matched, according to aspects of the present disclosure; and

FIG. 7 is a plot showing illustrative mapping error of our AI-driven CMS according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation.

Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in

an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

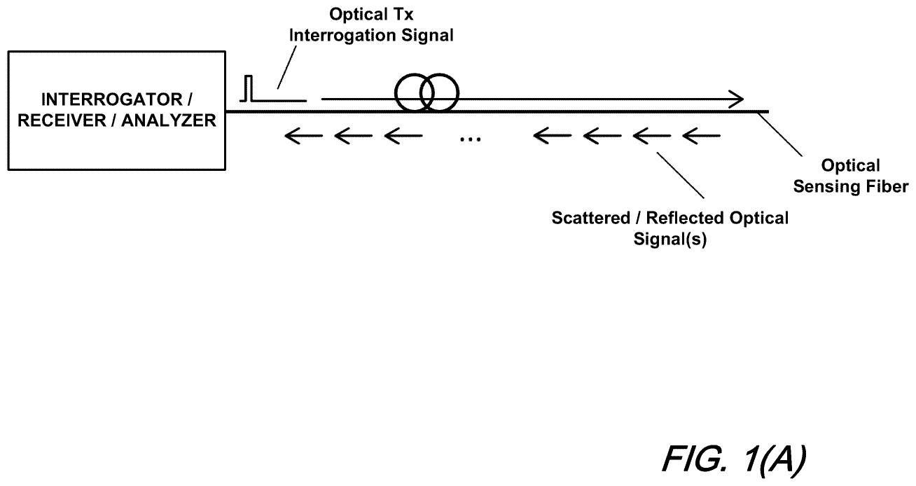

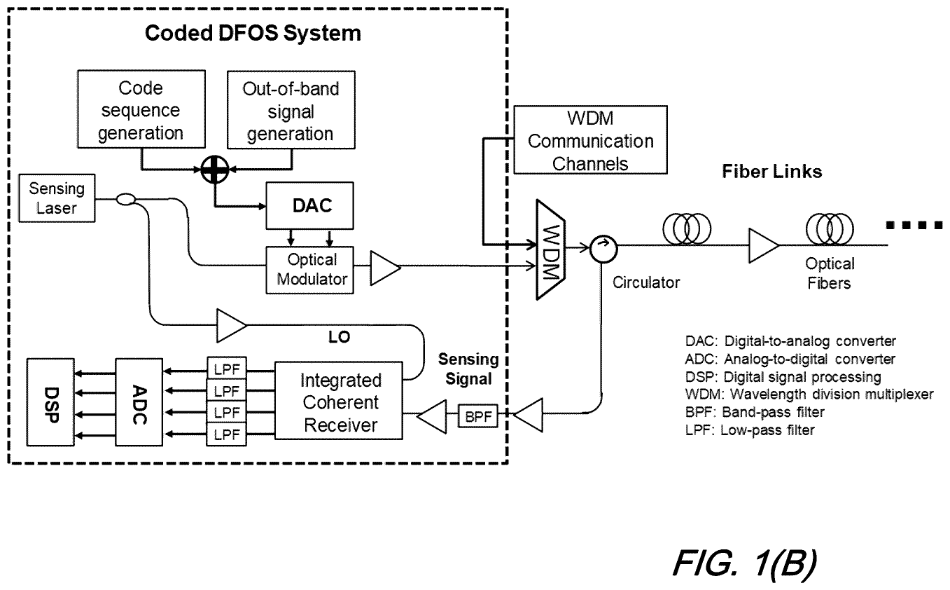

A schematic diagram illustrating the generalized arrangement and operation of a distributed fiber optic sensing system that may advantageously include artificial intelligence / machine learning (Al/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. According to aspects of the present disclosure, classification methods may be further used to detect and locate events or other environmental conditions including acoustic and/or vibrational and/or thermal along the length of the optical sensing fiber.

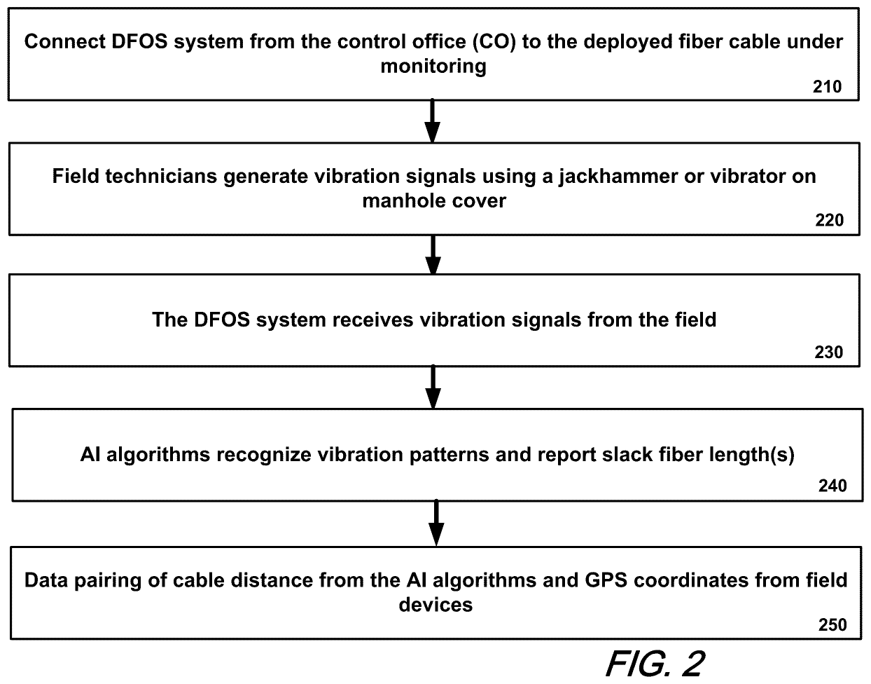

FIG. 2. Is a schematic flow diagram showing an illustrative prior art method for determining fiber optic cable location and mapping; With reference to this figure, various drawbacks may become apparent.

At Step 210, a DFOS system is connected from the central control office (CO) to the deployed fiber optic cable that is to be monitored. Such fiber optic cable becomes the sensor cable associated with the DFOS.

At Step 220, field technicians generate mechanical vibrations on a manhole cover, for example.

At Step 230, the DFOS system receives the vibration signals from the field.

At Step 240, Al algorithms recognize vibration patterns and report slack fiber locations along the length of the fiber optic cable.

Finally, at Step 250, data pairing of cable distance(s) and GPS coordinates of field devices/locations that generate the vibrations using the Al algorithms.

As those skilled in the art will understand and appreciate, such an operation may be particularly human labor intensive and operationally expensive for a service provider.

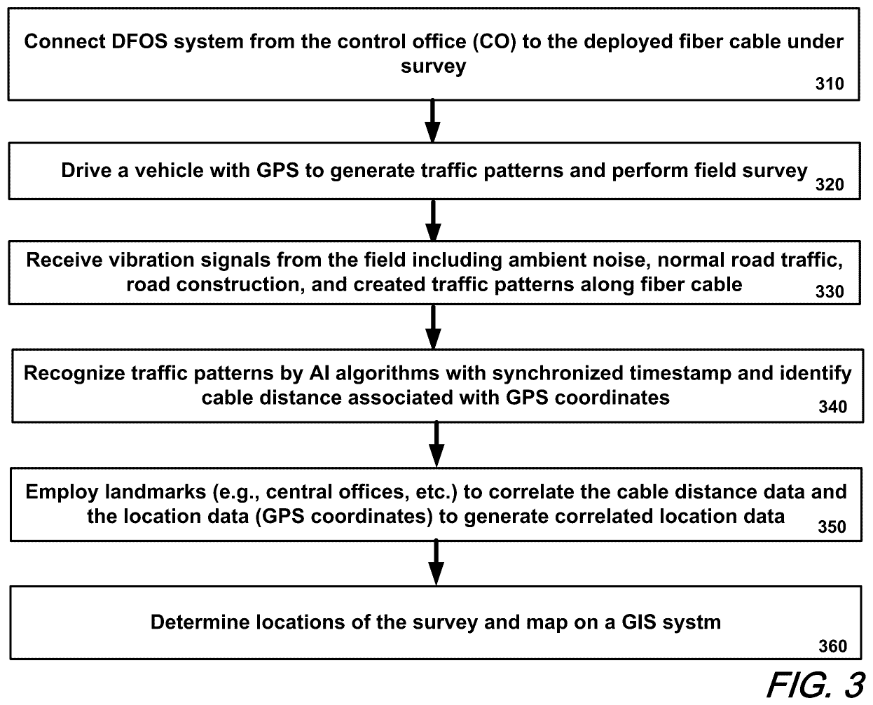

FIG. 3 is a schematic flow diagram showing an illustrative method for determining fiber optic cable locations and mapping according to aspects of the present disclosure. With reference to that figure, our inventive fiber optic locator and mapping operation may be understood.

At Step 310, a DFOS system that may be in a central control office to a deployed fiber optic cable that serves as a DFOS sensor fiber that will be employed in a field survey.

At Step 320, a vehicle with GPS device is driven along routes to generate detectable field traffic patterns for the field survey.

At Step 330, during DFOS operation, vibration signals are received from the field that include ambient noises, normal road traffic, road construction and created traffic patterns along the fiber cable route.

At Step 340, traffic patterns are recognized by Al algorithms with synchronized timestamp and cable distances associated with GPS coordinates.

At Step 350, employing landmarks (e.g., central offices, manholes, etc.) cable distance data and location data (GPS coordinates) are correlated to generate correlated location data.

At Step 360, locations of the survey are determined and located and mapped on a GIS system.

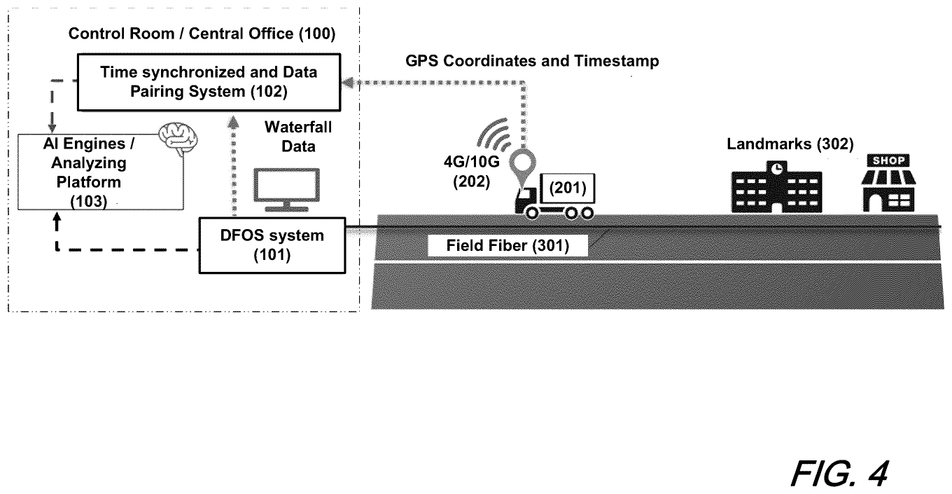

FIG. 4 is a schematic diagram showing illustrative system setup for determining fiber optic cable locations and mapping according to aspects of the present disclosure. As illustratively shown in this figure, a sensing layer is “overlaid” on an existing deployed fiber network. The distributed fiber optic sensing system (DFOS) (101) which can be distributed acoustic sensing (DAS) and/or distributed vibration sensing (DVS) is shown located in a central office/control office (CO) (100) for remote monitoring of an entire fiber optic cable route.

The DFOS system is optically connected to a field deployed, optical sensing/sensor fiber that provides sensing functions. As may be readily appreciated, the optical sensing fiber can be a dark fiber (no traffic), or an operational telecommunications fiber owned/operated/used by a service provider to provide one or more telecommunications services. A vehicle (201) is utilized in the survey and carrying a GPS device (202) which is time-synchronized with the data pairing system (102). By matching the time stamps of the GPS device and the DFOS system, the geographic location of a targeted location can be paired with optical sensor fiber distance from waterfall data and GPS coordinates in the A.I. platform (103).

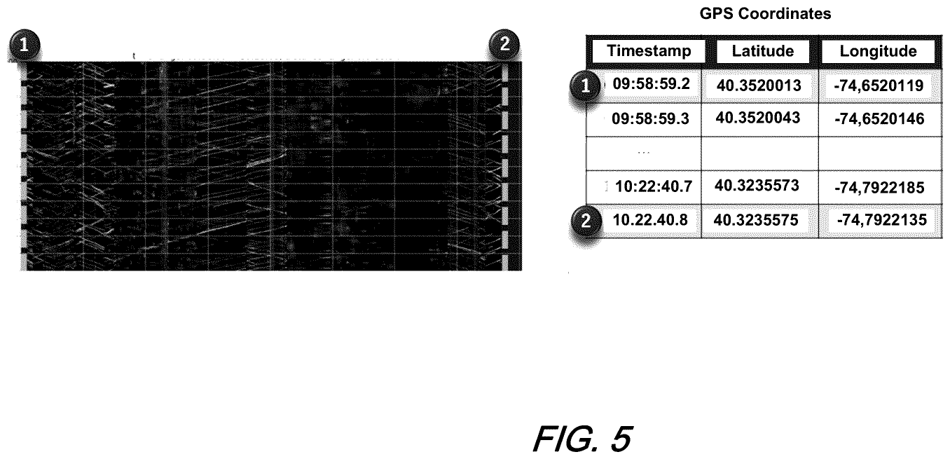

FIG. 5 is a schematic diagram showing illustrative field operations of AI-driven cable mapping system including fiber route map, sensing data received from DFOS system, and GPS coordinates from GPS device, according to aspects of the present disclosure. We note that the operations and requirements of our AI-driven auto-CMS (Cable Mapping System) may be realized from viewing this figure.

First, with respect to a route map that may be provided by a service provider/carrier, it is perfectly fine if such map is not up to date. The route map only guides the driver of the vehicle where to drive during the survey. Second, the vehicle carries a GPS while driving along the (fiber) route. During the driving, the GPS is synchronized with the DFOS system according to a timestamp. The corresponding fiber sensing data shown in the illustrative waterfall plots includes the traffic trajectory of the survey vehicle.

The GPS points—at least two—are matched to the waterfall data. GPS coordinates are to be known relative to landmarks (302) and are collected from the vehicle GPS device. The GPS coordinates includes at least two known locations that are selected as field reference points that may advantageously be the 2 end points of the fiber optic sensor namely, the two central offices that define the start and end point of the fiber optic sensor route, respectively.

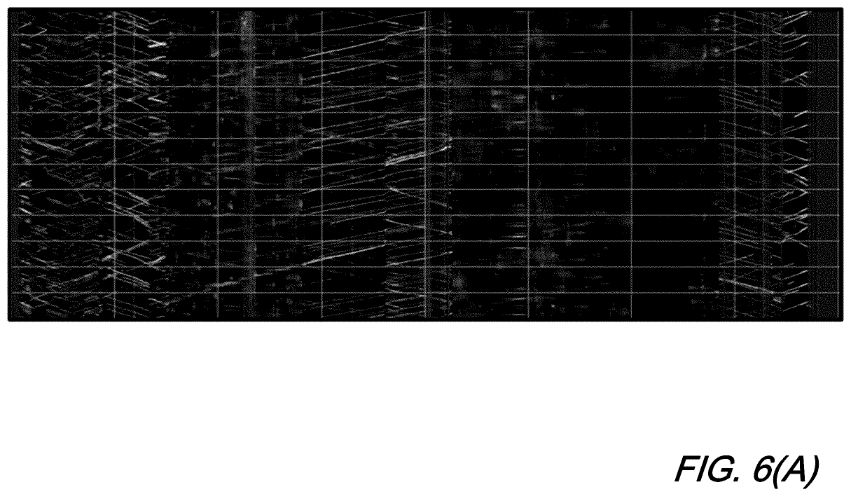

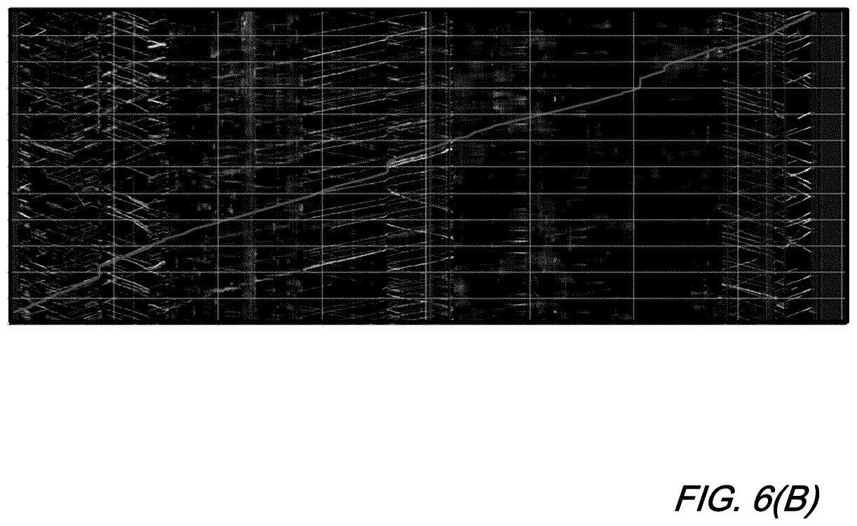

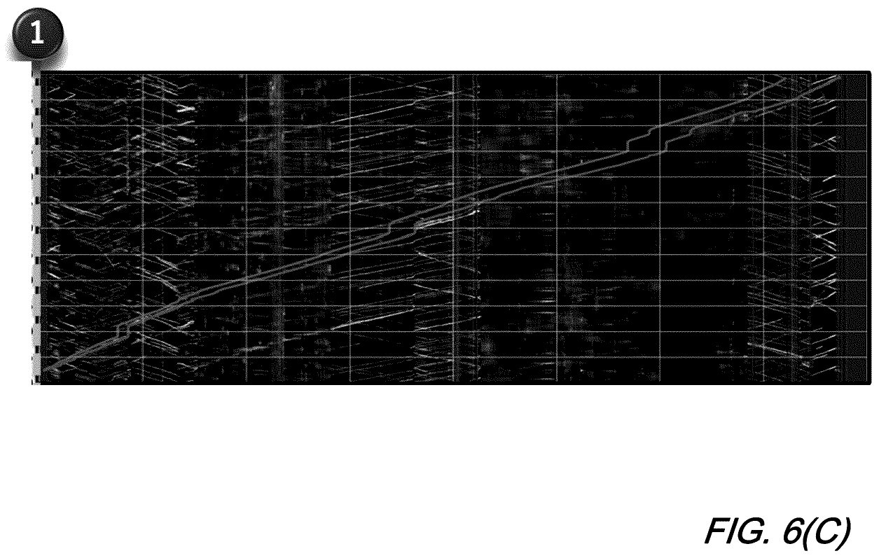

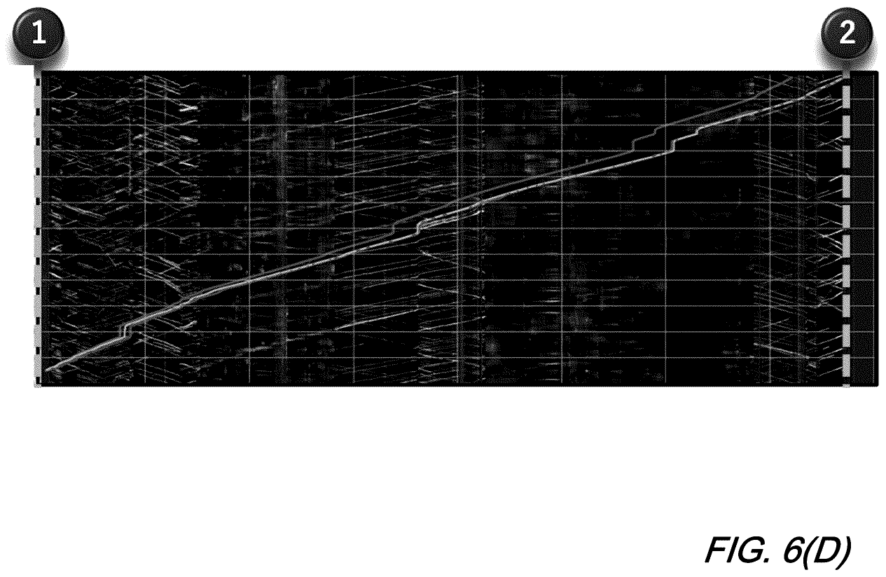

FIG. 6(A), FIG. 6(B), FIG. 6(C), and FIG. 6(D) are a series of plots showing operations data of automatic, AI-driven CMS according to the present disclosure in which: FIG. 6(A) shows received sensing data (waterfall traces) from DFOS system including survey vehicle and road traffic; FIG. 6(B) shows coordinated GPS information and DFOS sensing points based on timestamps with field reference points shown on map as dots; FIG. 6(C) is a trajectory plot if field reference point is matched; and FIELD 6(D) is a trajectory plot when 2 field reference points are matched, according to aspects of the present disclosure.

From the operations data plots we note that in FIG. 6(A), the received sensing data (waterfall traces) from the DFOS system included both survey vehicle and road traffic.

In FIG. 6(B), shown are coordinated GPS information and DFOS sensing points based on the timestamp. Surveyed field reference points are pinpointed on the plot in dots. The plotted trajectory matched to 100 field reference points (green line) is determined to be the ground truth of this survey. FIG. 3(C) shows the plotted trajectory if the survey only matched 1 field reference point—which is the central office of the fiber starting location. FIG. 3(D) shows the plotted trajectory when the survey only matched 2 field reference points which are the central offices of the fiber starting and ending locations.

From these results, it can be observed that only one field reference point is not providing good accuracy on this survey. However, if 2 field reference points are applied, the accuracy can be improved substantially.

FIG. 7 is a plot showing illustrative mapping error of our AI-driven CMS according to aspects of the present disclosure. If only 1 field reference point is employed, the mapping error is 3.4%. However, it can be reduced to 0.4% and lower when 2 or more field reference points are applied. Additionally, the cable mapping error is lower for buried cable sections as compared to aerial cable sections. From these results, the average mapping error may be expressed as follows.

$$average mapping error : \frac{{Σ}_{GPS points} ‖ mapped distance - ground truth distance ‖}{number of GPS points}$$

At this point, while we have presented this disclosure using some specific examples, those skilled in the art will recognize that our teachings are not so limited. Accordingly, this disclosure should only be limited by the scope of the claims attached hereto.

1. A cable mapping method comprising:
operating a distributed fiber optic sensing (DFOS) system configured to sense a route of interest;
operating a vehicle including a global positioning system receiver such that traffic patterns are generated;
detecting, by the DFOS, vibration signals from the route of interest;
identifying traffic patterns from the detected vibration signals and identifying a location along the route of interest by GPS coordinate; and
mapping the identifying location on a graphical information system (GIS).

2. The method of claim 1 further comprising:
Identifying traffic patterns from the detected vibration signals by artificial intelligence (Al) algorithms.

3. The method of claim 2 further comprising:
Identifying traffic patterns from the detected vibration signals by Al algorithms with synchronized timestamp and identify a DFOS optical sensor fiber cable distance associated with the GPS coordinate.

4. The method of claim 3 further comprising:
using landmarks along the route of interest, correlating the identified cable distance and GPS coordinate thereby generating correlated location data.

5. The method of claim 4 further comprising:
mapping the correlated location data on the GIS.

6. The method of claim 5 wherein the vibration signals include ambient noises, road traffic, road construction, and created traffic patterns along the route of interest.

7. The method of claim 6 wherein the landmarks include buildings, manholes, manmade and natural structures.

8. The method of claim 7 wherein the Al algorithm is performed by a deep neural network trained end-to-end of the DFOS optical sensor fiber cable.
